(19) United States
(12) Patent Application Publication
(10) Pub. No.: US 2020/0209895 A1
(43) Pub. Date: Jul. 2, 2020

(54) SYSTEM AND METHOD FOR SUPPORTING SAFE OPERATION OF AN OPERATING OBJECT

(71) Applicant: SZ DJI TECHNOLOGY CO., LTD., Shenzhen (CN)

(72) Inventors: Xiaodan WANG, Shenzhen (CN); Guofang ZHANG, Shenzhen (CN); Ming CHEN, Shenzhen (CN)

(21) Appl. No.: 16/811,781

(22) Filed: Mar. 6, 2020

Related U.S. Application Data
(63) Continuation of application No. PCT/CN2017/101284, filed on Sep. 11, 2017.

(51) Int. Cl. G05D 1/10; G05D 1/00; B64C 39/02

(52) U.S. Cl. CPC G05D 1/1064; G05D 1/1062; B64C 2201/141; B64C 39/024; G05D 1/0022

(57) ABSTRACT

A method for supporting safe operation of an operating object includes obtaining movement characteristic information of a moving object, determining, for the moving object, a safe operation distance relative to the operating object, determining whether the moving object poses a risk to the operating object based on an evaluation of the movement characteristic information of the moving object and the safe operation distance, and generating a warning signal in response to the moving object being determined to pose the risk.

### CROSS-REFERENCE TO RELATED APPLICATION

This application is a continuation of International Application No. PCT/CN2017/101284, filed Sep. 11, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The disclosed embodiments relate generally to operation safety, but not exclusively, to aerial vehicle operation safety.

### BACKGROUND

Aerial vehicles such as unmanned aerial vehicles (UAVs) can be used for performing surveillance, reconnaissance, and exploration tasks for various applications. The movement of such vehicles may need to be under control in order to alleviate the chance of colliding into other aerial vehicles, such as a commercial airliner or a helicopter. This is the general area that embodiments of the disclosure are intended to address.

### SUMMARY

Described herein are systems and methods that provide technical solution for supporting safe operation of an operating object. An operating object can obtain movement characteristic information of a moving object. The operating object can determine a safe operation distance relative to the operating object for the moving object. Furthermore, the operating object can determine whether the moving object poses a risk to the operating object, based on an evaluation of the movement characteristic information of the moving object and the safe operation distance. Then, the operating object can indicate to an operator of the operating object when the moving object poses a risk.

### BRIEF DESCRIPTION OF DRAWINGS

FIG. 1 shows an example of safe operation in accordance with embodiments of the disclosure.

FIG. 2 shows an example of a safe operation environment in accordance with embodiments of the disclosure.

FIG. 3 shows an example of an operating object in accordance with embodiments of the disclosure.

FIG. 4 shows an example of applying safe operation buffer zone at different time points in accordance with embodiments of the disclosure.

FIG. 5 shows a flowchart of supporting safe operation of an operating object, in accordance with various embodiments of the present disclosure.

FIG. 6 shows a flowchart of performing collision calculation and avoidance control for an operating object, in accordance with various embodiments of the present disclosure.

FIG. 7 shows a flowchart of applying flight restriction for a moving object, in accordance with various embodiments of the present disclosure.

FIG. 8 shows a computer control system that is programmed or otherwise configured to implement methods provided herein.

### DETAILED DESCRIPTION

The disclosure is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The description of the disclosure as following uses a commercial airliner as example for an operating object, and uses an unmanned aerial vehicle (UAV) as example for a moving object. It will be apparent to those skilled in the art that other types of operating objects and moving objects can be used without limitation.

In accordance with various embodiments, technical solution can be provided for supporting safe operation of an operating object. An operating object can obtain movement characteristic information of a moving object. The operating object can determine a safe operation distance relative to the operating object for the moving object. Furthermore, the operating object can determine whether the moving object poses a risk to the operating object, based on an evaluation of the movement characteristic information of the moving object and the safe operation distance. Then, the operating object can indicate to an operator of the operating object when the moving object poses a risk.

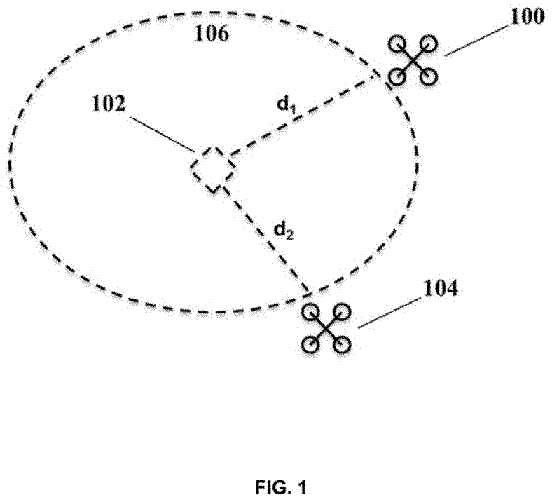

FIG. 1 shows an example of safe operation in accordance with embodiments of the disclosure. An object of interest, such as an operating object 102, may be provided. Flight of one or more moving objects, such as UAVs 100, 104, may be monitored or detected relative to the operating object. In some embodiments, safe operation distance (e.g., d1, d2) may be provided or prescribed. The UAV may be required to maintain at least the safe operation distance away from the operating object. In some embodiments, the safe operation distance(s) may define a safe operation buffer zone 106 for the operating object.

An operating object 102 may be a stationary object or a moving object. The operating object may be stationary or moving relative to a reference frame. The reference frame can be a relatively fixed reference frame (e.g., the surrounding environment, or earth). Alternatively, the reference frame can be a moving reference frame (e.g., a moving vehicle). The UAV may continuously maintain flight control in order to avoid the operating object (e.g., to avoid a collision).

A stationary object may have a moving speed of substantially zero in latitude, longitude, and altitude (e.g., V=0). The stationary object may have a linear velocity, linear acceleration, angular velocity, and/or angular acceleration of zero. The stationary object may be stationary with respect to an inertial frame. An inertial frame may be an environment within which the operating object is disposed. The inertial reference frame may be the Earth. A stationary object may be affixed with respect to the inertial reference frame. Alternatively, the stationary object may be capable of moving relative to the inertial reference frame, but may be non-moving at the moment. In some embodiments, a stationary object may not be capable of moving on its own power. The stationary object may require aid of another object in order to move. A stationary object may remain substantially stationary within an environment. Examples of stationary objects may include, but are not limited to landscape features (e.g., trees, plants, mountains, hills, rivers, streams, creeks, valleys, boulders, rocks, etc.) or manmade features (e.g., structures, buildings, roads, bridges, poles, fences, unmoving vehicles, signs, lights, etc.). Stationary objects may include large operating objects or small objects of interest. In some instances, the stationary object may correspond to a selected portion of a structure or physical item.

A moving object may move with respect to one, two, or three axes. The moving object may move linearly with respect to one, two, or three axes, and/or may rotate about one, two or three axes. The axes may orthogonal to one another. The axes may include a yaw, pitch, and/or roll axis. The axes may be along a latitude, longitude, and/or altitude direction. The moving object may have a moving speed that is non-zero (e.g., V 0). The moving speed may be non-zero with respect to one, two or three axes. The moving object may move with respect to an inertial reference frame. A moving object may be capable of moving with respect to the inertial reference frame. The moving object may actually be in motion with respect to the inertial reference frame. The moving object may be capable of moving on its own power. The moving object may be capable of self-propulsion.

A moving object may be capable of moving within the environment. The moving object may always be in motion, or may be at motions for portions of a time. For example, the moving object may be a car that may stop at a red light and then resume motion, or may be a train that may stop at a station and then resume motion. The moving object may move in a fairly steady direction or may change direction. The moving object may move in the air, on land, underground, on or in the water, and/or in space. The moving object may be a living object (e.g., human, animal) or a non-living object (e.g., moving vehicle, moving machinery, object blowing in wind or carried by water, object carried by living target). Moving objects may be large or small operating objects (objects of interest). A moving object may be any operating object configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; a movable structure or frame such as a stick, fishing pole; or a train), under the ground (e.g., a subway), in space (e.g., a spaceplane, a satellite, or a probe), or any combination of these environments.

A moving object may be capable of moving freely within the environment with respect to six degrees of freedom (e.g., three degrees of freedom in translation and three degrees of freedom in rotation). Alternatively, the movement of the moving object can be constrained with respect to one or more degrees of freedom, such as by a predetermined path, track, or orientation. The movement can be actuated by any suitable actuation mechanism, such as an engine or a motor. The actuation mechanism of the moving object can be powered by any suitable energy source, such as electrical energy, magnetic energy, solar energy, wind energy, gravitational energy, chemical energy, nuclear energy, or any suitable combination thereof. The moving object may be self-propelled via a propulsion system, such as described further below. The propulsion system may optionally run on an energy source, such as electrical energy, magnetic energy, solar energy, wind energy, gravitational energy, chemical energy, nuclear energy, or any suitable combination thereof.

In some instances, the moving object can be a vehicle, such as a remotely controlled vehicle or manned vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the moving object to take off from a surface, land on a surface, maintain its current position and/or orientation (e.g., hover), change orientation, and/or change position.

The operating object may be live subjects such as people or animals and/or a vehicle carrying the live subjects, e.g., a limousine carrying a president or other government official, or a car carrying a VIP. The live subjects can include people or animals. For example, the operating object may be an important person, such as a government official. The operating object may be a person of specialized status, who may experience elevated security risks and/or precautions.

In various embodiments, the operating object may include a passive object or an active object. An active object may be configured to transmit information about the operating object, such as the operating object's GPS location. The information may be transmitted to a UAV, server, or any other type of external device. Information may be transmitted via wireless communication from a communication unit of the active target to a communication unit of the external device, such as a UAV. A passive object is not configured to transmit information about the operating object.

An operating object may be a region or area within an environment. The operating object may be a physical item within an environment. The operating object may or may not be visually distinguishable from its surroundings. An operating object may be any natural or man-made objects or structures such geographical landscapes (e.g., mountains, vegetation, valleys, lakes, or rivers), buildings, vehicles (e.g., aircrafts, ships, cars, trucks, buses, vans, or motorcycle). An operating object may be an active object or may be associated or affixed to an active object.

An operating object may be a sensor that may collect information about an object. The operating object may have an associated sensor that may be integral to the operating object, may be affixed to the operating object, or may be separable from the operating object. The sensor may be removably attached to the operating object, or may be a completely separate from the operating object. The sensor may be the operating object, and vice versa. The sensor may be provided at the same location or separate location as the operating object.

An operating object may have an associated restricted region, such as a safe operation buffer zone 106. An operating object may be within the associated safe operation region. The restricted region may encompass the operating object. The operating object may be a physical location, or a structure, landmark, feature, transportable item, vehicle, or any other type of object. An operating object may comprise, or be placed at, one or more locations such as, but not limited to, airports, flight corridors, military or other government facilities, locations near sensitive personnel (e.g., when the President or other leader is visiting a location), vehicles carrying sensitive personnel or cargo, nuclear sites, research facilities, private airspace, de-militarized zones, certain jurisdictions (e.g., townships, cities, counties, states/provinces, countries, bodies of water or other natural landmarks), national borders (e.g., the border between the U.S. and Mexico), or other types of no-fly zones. Associated safe operation regions may be provided accordingly. In some embodiments, an active object, such as a sensor, may transmit information that is used to determine a safe operation region.

One or more operating objects may be configured with a wireless data transmitter, such as an automatic broadcasting system, which may broadcast information. The information may comprise one or more parameters of the operating object. Parameters of the operating object may include, but are not limited to, a unique identity of the operating object, an object type or classification, one or more physical characteristics of the operating object, such as whether the operating object is capable of movement, types of movements and/or speeds that the operating object is capable of, or any specialized status of an individual associated with the operating object or with the operating object itself. The information can comprise location and/or movement information of the operating object. The information of the operating object may be provided on a periodic basis, in real-time, and/or in response to an event. The location and/or movement information may reflect the most up-to-date information about the operating object. The location and/or movement information may reflect information within a predetermined period of time. The predetermined period of time may be a time period most recent (e.g., closest in time) to a moment at which a safe operation distance is being calculated. The location and/or movement information may comprise the last known location, velocity, direction, direction of velocity vector, acceleration, direction of acceleration vector received from an operating object within the predetermined period of time. The location and/or movement information may include, but is not limited to, latitude, longitude, altitude, orientation with respect to a pitch, yaw, or roll axis, linear speed, angular speed, linear acceleration, angular acceleration, direction, time, or other information. The location and/or movement information may be determined with aid of a location unit. The location unit may comprise a global positioning system (GPS) unit that may determine geospatial coordinates of the operating object. The positioning unit may comprise one or more inertial sensors, such as one or more accelerometers, gyroscopes, magnetometers, or any other type of sensor that may aid in detecting motion of the operating object (e.g., linear and/or angular motion). The location unit may utilize images, infrared signals, radio signals, and/or any other type of information in providing location and/or movement information of the operating object. The location unit may receive information from outside the operating object (e.g., satellites, external sensors), and/or information that is self-contained to the operating object (e.g., from inertial sensors).

The location unit may perform functions of receiving or measuring data (e.g., information about the associated operating object). The location unit may comprise a receiving module and/or a measurement module. The data receiving module may receive an external signal (e.g., from a GPS receiver, a communication network receiving module (e.g., SIM card), a satellite data receiving module) in real-time. The measurement module may measure one or more parameters of the operating object (e.g., accelerometer, gyroscope, compass, barometer, pitot/speed meter). Different parameters may be measured and received for different objects of interest; hence, the data receiving and measuring module can be automatically or manually adjusted based on a type of the operating object.

A moving object, such as an UAV 100, 104 may be prevented from entering a safe operation buffer zone 106. Any description herein of a UAV may apply to any type of aerial vehicle, or any other type of moving object, or vice versa. A UAV may be capable of traversing an environment. The UAV may be capable of flight within three dimensions. The UAV may be capable of spatial translation along one, two, or three axes. The one, two or three axes may be orthogonal to one another. The axes may be along a pitch, yaw, and/or roll axis. The UAV may be capable of rotation about one, two, or three axes. The one, two, or three axes may be orthogonal to one another. The axes may be a pitch, yaw, and/or roll axis. The UAV may be capable of movement along up to 6 degrees of freedom. The UAV may include one, two or more propulsion units that may aid the UAV in movement. The propulsion units may be configured to generate lift for the UAV. The propulsion units may include rotors. The moving object may be a multi-rotor UAV.

The UAV may be capable of manually-controlled flight, semi-autonomous flight, or autonomous flight. In some embodiments, one or more autonomous actions of the UAV may supersede manually controlled flight, or previously instructions for semi-autonomous or autonomous flight. For example, a UAV may be forced to remain outside of a restricted zone. The UAV may be forced to take action when approaching a restricted zone, or when close to a restricted zone. For example, the UAV may be forced to alter the UAV's path to remain outside the restricted zone. The UAV may be forced to maintain at least a safe operation distance away from the operating object. The UAV may fly at a safe operation distance, or any distance greater than the safe operation distance, away from the operating object. A UAV may not be permitted to fly within a safe operation distance of an operating object. If the UAV is within the safe operation distance of the operating object, the UAV may be forced to land, hover, or increase the UAV's distance until the UAV is at least as far away from the operating object as the safe operation distance. If the UAV is on the ground within the safe operation distance of the operating object, the UAV may be prevented from taking off. If the operating object moves away so that the UAV is subsequently further than the safe operation distance from the operating object, the UAV may then be allowed to take off. Such autonomous flight responses are provided by way of example only, and additional flight responses by the UAV may be possible.

The UAV may be prevented from entering the restricted region by being forced to maintain at least a certain safe operation distance d1, d2 away from the operating object. The safe operation distance may depend on a characteristic of the operating object (e.g., object classification, object movement, timing for the operating object to process and/or transmit information), a characteristic of the UAV (e.g., UAV classification, UAV movement, UAV physical specifications, timing for the UAV to process received information, timing for the UAV to respond), a characteristic of communications between the UAV and the operating object (e.g., timing for information to be transmitted from the operating object to the UAV), and/or any other situational characteristics (e.g., environmental conditions such as weather).

For example, a first UAV 100 may be required to maintain at least a distance d1 from the operating object 102. A second UAV 104 may be required to maintain at least a distance d2 from the operating object 102. The distances d1, d2 may be the same or may be different from one another. The distances may differ depending on a characteristic of the UAV. For example, the first UAV may have a slower flight controller than the second UAV, and may be required to keep a greater distance away from the operating object than the second UAV.

In another example, the restricted region around the operating object may be a circle. For instance, when approaching from a first direction, a UAV 100 may be required to maintain at least a distance d1 from the operating object. When approaching from a second direction, the UAV 104 may be required to maintain at least a distance d2 from the operating object. Thus, depending on circumstances, for the same operating object, the safe operation distances for the UAV may be same or differ. When considering the safe operation distance around the UAV in all directions (e.g., 360 degrees around the UAV), a restricted region may be defined by the safe operation distances around the UAV. The safe operation distances around the UAV may define a boundary of the restricted region. In some embodiments, the safe operation distances may be determined in a lateral direction. The safe operation distances may be determined in a vertical direction and/or a combination of lateral and/or vertical direction. The safe operation distances around the UAV in lateral and/or vertical directions may define a flight-restriction space. Additionally, any description herein of a restricted region may apply to a three-dimensional flight-restriction space.

The safe operation distance may change over time. In some embodiments, the safe operation distance may be updated periodically (e.g., at least as frequently as every few minutes, every minute, every few seconds, every second, every few tenths of a second, every tenth of a second, every hundredth of a second, every milliseconds), continuously in real-time, and/or in response to one or more events. Examples of one or more events may include, but are not limited to, detected action by a UAV, a request by a UAV, a detected action by the operating object, a request by the operating object, a request from a third party device (e.g., server, remote controller), or an event associated with a communication system. Alternatively, the safe operation distance may remain the same and not change over time.

The operating object may be a moving or stationary object. For example, the operating object may be moving at a velocity. The automated broadcasting system may be moving in the same manner as the operating object (or may be the operating object itself). The UAV may be required to maintain at least a safe operation distance away from the operating object. The safe operation distance may remain substantially the same or may change as the operating object and/or UAV moves. The safe operation distance may change over time, or may remain substantially the same.

A restricted region may be a static region corresponding to a stationary object. The restricted region may be a 2-D or 3-D safe operation region. An operating object may compare a UAV location relative to the safe operation region. Based on the safe operation distance and a distance between the UAV and the operating object, the operating object can determine and apply an avoidance measure. In some embodiments, the UAV may compare its own geo-spatial coordinates with geo-spatial coordinates of the operating object to calculate the distance between the UAV and the operating object and/or determine whether the UAV is within a fight restricted zone. This information may be used to make an assessment of whether the UAV is to take a flight response measure.

For example, a 3-D restricted region may be defined based on GPS coordinates and height of a stationary object (e.g., a non-moving object with a range of motion of substantially zero in latitude, longitude, and altitude). The UAV may compare its own GPS coordinates with the information of the safe operation region, and may execute a flight response based on the distance between the UAV and the operating object. For example, a UAV's flight response may comprise performing a braking operation if it is detected that the UAV is approaching the operating object. In another example, the UAV's flight response may be to continue flying but veer away from the safe operation region. In another example, the UAV's flight response may be to change its speed (e.g., accelerate or decelerate). In another example, the UAV's flight response may be to change its altitude (e.g., fly higher or lower than its current position). In another example, the UAV's flight response may be to change its direction (e.g., make a left turn or a right turn by a certain number of degrees). In another example, the UAV's flight response may be to land (e.g., immediately or to return to a predetermined location). The three-dimensional restricted region may be characterized by restrictions in ranges corresponding to one or more of latitude, longitude, and/or altitude. For example, a UAV may be instructed to maintain at least a restricted region of 10 meters away from a building in all lateral directions, but can fly over the building from its roof. The restrictions in any of the directions (e.g., latitude, longitude, altitude) may be the same or may be different.

A safe operation distance may be determined for the UAV relative to an operating object. The safe operation distance may determine a portion of a boundary of a safe operation region. If a UAV is within a safe operation distance relative to the operating object for a particular moment in time, the UAV may be within the associated restricted region for that moment in time.

In some embodiments, a safe operation distance may depend on one or more physical characteristics of the operating object (e.g., speed). For instance, the operating object may be a stationary object or a moving object. In some embodiments, the safe operation distance may depend on how quickly the operating object is moving. For example, it may be desirable to have a greater safe operation distance relative to an operating object that is moving, in case the operating object moves in a way that may bring about a collision. For example, an operating object may be a UAV, which may have a safe operation distance of at least d1. In another example, an operating object may be a land-bound vehicle, a UAV may have a safe operation distance of at least d2. The UAV may be capable of moving more quickly than the land-bound vehicle, which may mean d1>d2. When an operating object is a stationary object, such as a sensor on a building, a UAV may have a safe operation distance of at least d3. Since the building is not moving at all, d1>d3, and/or d2>d3.

In some implementations, the safe operation distance may depend on the characteristics of how the operating object is moving. For example, operating objects that may have a more erratic characteristic movement, or a greater degree of freedom of motion, may have a greater safe operation distance, relative to an operating object that is a more stable or predictable type of movement, or more restricted types of movement. For example, a UAV 400 may have a greater degree of motion in its flight, or a more unpredictable type of flight path, compared to a land-bound vehicle that may be confined to moving on the ground, and/or along a road. A greater safe operation distance may be provided when the operating object is the UAV, rather than when the operating object is a land-bound vehicle.

The safe operation distance may depend on a direction that the operating object is moving relative to the UAV. For instance if the operating object is moving toward the UAV, a greater safe operation distance may be provided compared to if the operating object is moving away from the UAV. This greater safe operation distance accounts for the time needed for the UAV to brake (e.g., reduce speed), land (e.g, reduce speed to zero), or change its flight path relative to the operating object (e.g., to take evasive action to avoid a collision with the operating object). If the operating object is moving away from the UAV, a smaller safe operation distance may be provided, since the UAV is less likely to be required to brake (e.g., reduce speed), land (e.g, reduce speed to zero), or change its flight path relative to the operating object (e.g., to take evasive action to avoid a collision with the operating object).

The safe operation distance may depend on a classification or priority of an operating object and/or an associated person. For instance if the operating object is very important for safety (e.g., an airport) or political reasons (e.g., a government building), a greater safe operation distance may be provided compared to if the operating object is less important (e.g., an office building or a private citizen's home). This greater safe operation distance accounts for the time needed for the UAV to brake (e.g., reduce speed), land (e.g, reduce speed to zero), or change its flight path relative to the operating object (e.g., to take evasive action to avoid a collision with the operating object).

The safe operation distance may depend on how quickly information about the operating object is collected, processed, and transmitted. For instance if this information takes a significant amount of time relative to the speed of the operating object (e.g., the operating object has a high speed relative to the speed of the UAV, such as an aircraft, a train, or a car) or the speed of the UAV (e.g., the UAV is moving at a high speed), a greater safe operation distance may be provided compared to if this information takes an insignificant amount of time relative to the speed of the operating object (e.g., the operating object does not have a high speed relative to the speed of the UAV, such as a stationary object) or the speed of the UAV (e.g., the UAV is moving at a low speed).

In some embodiments, the safe operation distance may depend on one or more characteristics of the UAV (e.g., maximum speed, size, maneuverability, cost for the UAV to take a flight response measure, classification or priority of the UAV, the rate at which information is communicated between the UAV and the operating object, or the rate at which information is processed at the UAV).

The safe operation distance may depend on the maximum speed of the UAV. For instance if the UAV has a high maximum speed, a greater safe operation distance may be provided compared to if the UAV has a low maximum speed. This approach assures greater protection in the event of malfunction of the UAV causes unreliable or unpredictable operation.

The safe operation distance may depend on the size of the UAV. For instance if the UAV has a large size, a greater safe operation distance may be provided compared to if the UAV has a small size. This approach assures greater protection in the event of collision between the UAV and an operating object, since a heavier UAV is capable of inflicting greater damage and poses greater risk to operating objects and people.

The safe operation distance may depend on the maneuverability of the UAV. For instance if the UAV has a low maneuverability, a greater safe operation distance may be provided compared to if the UAV has a high maneuverability. This approach assures greater protection in the event of the sudden appearance of an operating objector other event which may trigger a flight response for the UAV.

The safe operation distance may depend on the cost for the UAV to take a flight response measure. For instance if the UAV is flying at a high altitude or has a low remaining battery capacity, and hence has a high cost to perform a landing response, a greater safe operation distance may be provided compared to if the UAV is flying at a low to moderate altitude or has sufficient remaining battery capacity, and hence has a low to moderate cost to perform a landing response. This approach assures greater protection in the event of a sudden appearance of an operating objector other event which may trigger a flight response for the UAV.

The safe operation distance may depend on the classification or priority of the UAV. For instance if the UAV has a high priority, a greater safe operation distance may be provided compared to if the UAV has a low priority. This approach assures greater protection for a UAV against collisions because of the valuable nature of the UAV. The UAV may have high priority because of its high value, its valuable payload, and/or its high-priority passengers or associated user.

The safe operation distance may depend on the rate at which information is communicated between the UAV and the operating object. For instance if the communication between the UAV and the operating object occurs at a low rate, a greater safe operation distance may be provided compared to if the communication between the UAV and the operating object occurs at a high rate. This approach assures greater protection for a UAV which may have slow communication with the operating object and hence may need more time to determine a course of action during operation.

The safe operation distance may depend on the rate at which information is processed at the UAV. For instance if the UAV processes information at a low rate, a greater safe operation distance may be provided compared to if the UAV processes information at a high rate. This approach assures greater protection for a UAV which may have slow performance and hence may need more time to determine a course of action during operation.

The safe operation distance may depend on the communication time for the operating object to communicate with the UAV. For instance if the UAV communicates with the operating object with a relatively long communication time, a greater safe operation distance may be provided compared to if the UAV communicates with the operating object with a relatively short communication time. For instance a wireless communication link between the UAV and the operating object may be slow at large distances between the UAV and the operating object, or if the wireless network experiences network congestion, or if the UAV and the operating object communicate indirectly through a common network (e.g., a cloud network). The communication time between the UAV and the operating object may depend on a network latency of a communication network through which information is transmitted. For instance, an amount of time required to transmit information about a location of the operating object to the UAV may depend on a network latency of the communication network through which the information about the location of the object if interest is transmitted. Network latency may be an expression of the amount of time it may take for a data packet to travel from the operating object to the UAV or vice versa. Network latency may depend on network congestion, travel path, queuing delay, processing delay, buffer bloat, environmental conditions, signal strength, available bandwidth, or any other factors. This approach assures greater protection for a UAV which may have slow performance and hence may need more time to determine a course of action during operation.

The safe operation distance may depend on environmental conditions, e.g. weather. For instance if the UAV is operating in an environment with high wind conditions, a greater safe operation distance may be provided due to the possible erratic nature of the UAV's flight. For instance if the UAV is operating in a foggy or similar low-visibility environment, a greater safe operation distance may be provided due to the possible unreliable operation of sensors or the possible unreliable detection of the operating object.

A safe operation distance may be generated for a UAV relative to the operating object. The UAV may keep at a minimum the safe operation distance away from the operating object. In some embodiments, the safe operation distance may be generated based on an amount of time for one or more processes that may occur at the operating object, at the UAV, and/or between the operating object and/or UAV. The safe operation distance may depend on an amount of time for data to be collected and/or processed at the operating object and/or UAV.

A UAV may take a flight restriction measure when the UAV is approaching or within a restricted region of an operating object. It may be determined that the UAV is within a restricted region when the UAV is within a safe operation distance of the operating object. Examples of flight restriction measure may include, but are not limited to, preventing the UAV from taking off, forcing the UAV to land immediately, forcing the UAV to land after a set period of time, forcing the UAV to decrease altitude, forcing the UAV to increase altitude (e.g. to a predetermined altitude), forcing the UAV to hover, brake, change flight direction, or being forcing the UAV to return automatically to a pre-set location. In some embodiments, in addition or as an alternative to taking the flight response measure, a user of the UAV may receive a warning. The warning may be indicative of an operational status of the UAV and/or the types of flight-response measures that may be instituted if the user does not avoid the safe operation region.

In some embodiments, the flight restriction measure may be determined based on an operational status of the UAV. Examples of operational status of the UAV may include, the UAV being powered on or powered off, the UAV being in flight or being in a landed state, the UAV being within or outside a safe operation region, or the UAV having a projected trajectory that does intersect or does not intersect a safe operation region.

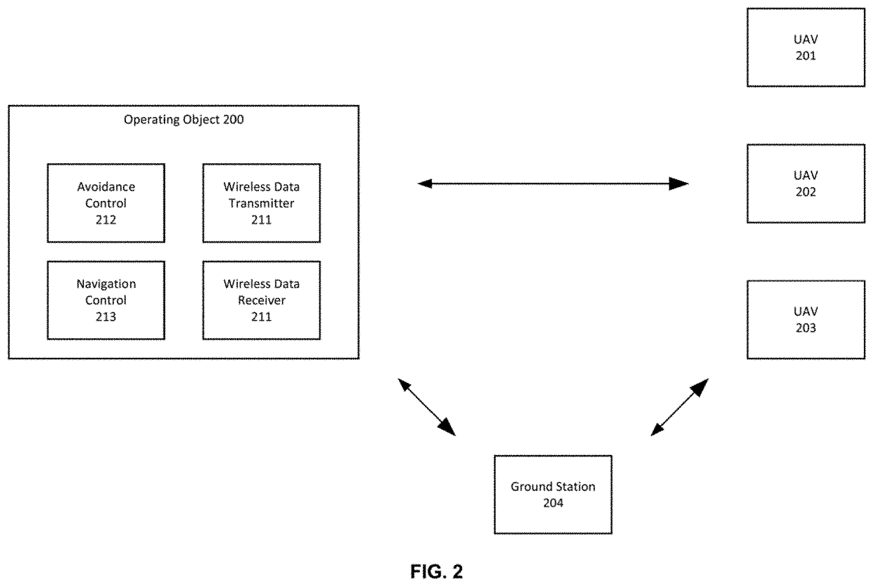

FIG. 2 shows an example of a safe operation environment in accordance with embodiments of the disclosure. An operating object 200 may be provided. The movement of one or more moving objects, such as UAVs 201-203, may be monitored and detected relative to the operating object.

In various embodiments, the operating object can detect or receive information about the UAVs via a wireless data receiver 211. For example, such information may be received directly from a UAV. Alternatively, such information may be received via aground station 204.

In various embodiments, a safe operation distance may be prescribed (or determined). The UAV may be required or forced to maintain at least a safe operation distance away from the operating object or may be prevented from entering into the safe operation distance relative to the operating object. In some embodiments, the safe operation distance(s) may define a restricted region (i.e., a safe operation region or a safe operation buffer zone) for the operating object. The safe operation buffer zone relative to the same operating object may be prescribed differently for different moving objects, since the safe operation distance for each moving object may be different due to the difference in movement characteristic properties of the different moving objects.

In various embodiments, the operating object can take advantage of various control units or systems for operation control. For example, a commercial airliner can use a navigation control system 213 for controlling the navigation and can use an avoidance control 212 for applying various avoidance measure to ensure navigation safety.

Furthermore, an operating object may comprise a wireless data transmitter 211, such as a beacon which may be physically or operably coupled to the operating object. (In some cases, the operating object may be the beacon itself.) For example, the beacon may be an automatic broadcasting system. The beacon may broadcast various information, including but not limited to movement characteristic information and various safe operation or flight restriction information. The beacon may broadcast information so that it may be received by untargeted recipients of any type that is capable of detecting information broadcast in a particular manner (e.g., particular frequency). Alternatively, the beacon may transmit information in a targeted manner so that only intended recipients may receive the information. The information may or may not be encrypted. Any description herein of an automatic broadcasting system may apply to any type of beacon or object of interest that may transmit information.

In one embodiment, a safe operation environment may be provided for a commercial airline. The commercial airliner may provide one or more signals (e.g., data) which can be pushed to the UAV as necessary. The data may be pushed continuously or only when the UAV is within a certain range of the automatic broadcasting system (e.g., on the commercial airline) for security purposes. When data is pushed to the UAV, the UAV may execute one or more appropriate flight control responses as necessary (e.g., stop moving forward or land).

In other embodiments, the operating object, such as a commercial airliner, may establish a communication link with the ground station 204. The operating object may receive and send signal data to the UAV via the ground station. For example, the ground station may push data to the UAV or receive data from the UAV, if predetermined condition is satisfied (e.g., when the UAV is in the range of the ground station).

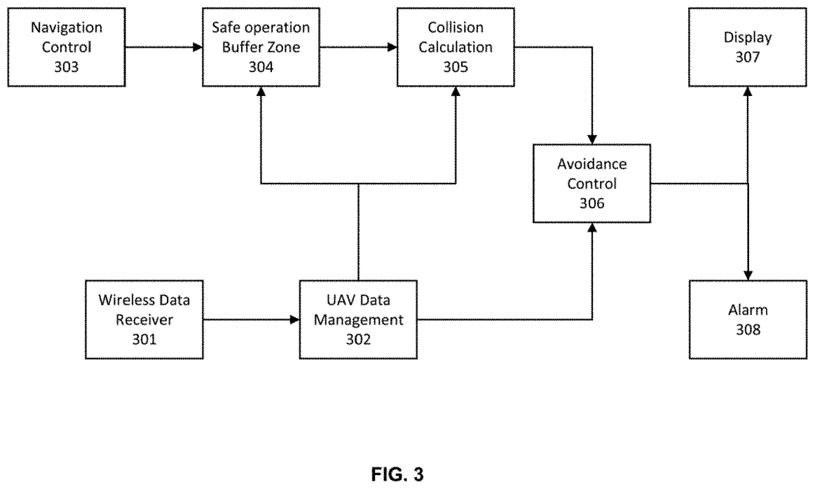

FIG. 3 shows an example of an operating object in accordance with embodiments of the disclosure. As shown in FIG. 3, an operating object 300 may be equipped with a wireless data receiver 301, such as an ADS-B data receiver, which can receive information such as the location, altitude, current speed, maximum speed, and identification information from the UAVs via different data communication channels in real time.

Optionally, a UAV data management system 302 can store and manage the received UAV information in a memory or a local storage device on-board the operating object. Alternatively, the received UAV information can be transmitted to and saved in a database that is remote from the operating object. Also, the UAV data management system can obtain additional information about the UAV based on the received UAV information. For example, the operating object may be able to identify and locate an operator of a UAV based on the received UAV identification information.

In various embodiments, an operation control system may be used for controlling the operation of the operating object. For example, a navigation control system 303 onboard a commercial airliner can control the course of navigation by the commercial airliner. Based on the current operation states (such as movement characteristic information of the airliner) and received UAV information, the navigation control system can determine a safe operation distance or a safe operation buffer zone 304 for preventing a UAV from interfering with or risking the safe navigation of the commercial airliner.

Also, the navigation control system can perform a course confliction analysis, such as collision calculation 305, to determine whether a UAV poses a risk (either a present risk or a potential risk) to the navigation of the airliner. The operating object can perform course confliction analysis, such as real-time collision calculation, to identify a present risk based on the current operation state of the operating object (e.g. a commercial airliner) and the received UAV information. Also, the operating object can perform predictive collision calculation to identify a potential risk at a future point (e.g. a future time) based on a predetermined operation plan, such as a flight plan for a commercial airliner, and the received UAV information.

Then, after detecting a risk condition, the operating object may direct an avoidance control system 306, such as an avoidance control system onboard or off-board the airliner, to start an avoidance control process, e.g. by ringing an alarm 308 or displaying a warning message 307. For example, once the avoidance control system determines that there is a present risk or a potential risk, the avoidance control system can provide a warning message or a warning signal to an operator of the operating object, e.g. a pilot for a commercial airliner or a personnel in the control tower. When either a present risk or a potential risk exists, the operating object can convey such information to an operator of the operating object, e.g. a pilot of the commercial airliner or an operator in the control tower. There are different ways for conveying such information to the operator of the operating object. For example, the operating object can display a warning message or a warning signal on a user interface or a monitoring screen. Alternatively, the operating object can generate a buzz noise or a vibration to alert the operator of the operating object. Then, an operator of the operating object, such as the pilot, can manually or automatically apply an avoidance measure to avoid the incoming UAV. For example, an avoidance measure can be sending a warning message to an operator of the UAV and demanding or instructing the UAV to move away from its current course (such as forcing the UAV to land or adjust its altitude or moving direction to avoid the incoming operating object). Alternatively, the avoidance measure can be directing the operating object to perform an active avoidance maneuver, such as adjusting the height of the operating object or using an alternative route if possible.

In various embodiment, the operating object can optimize the information that are conveyed to the operator of the operating object. For example, the operating object may not provide such information to the operator when the flight of an UAV pose no risk to the operating object, in order to simplify the operating control environment and ensure the safe operation of the operating object. Additionally, the operating object may convey such information in different manners depending on the seriousness of the risk. For example, the operator of the operating object may apply an active avoidance measure when the flight of an UAV poses risk to the operating object at the present time. Alternatively, the operator of the operating object may take various preventive measures when the flight of an UAV does not pose a risk on the operating object at the present time but may become a risk at a future point in the course of the operation, according to a predetermined operation plan of the operating object. As the operation of the operating object and the flight of the UAV continue, the pilot may need to take an active avoidance measure when the UAV becomes a present risk.

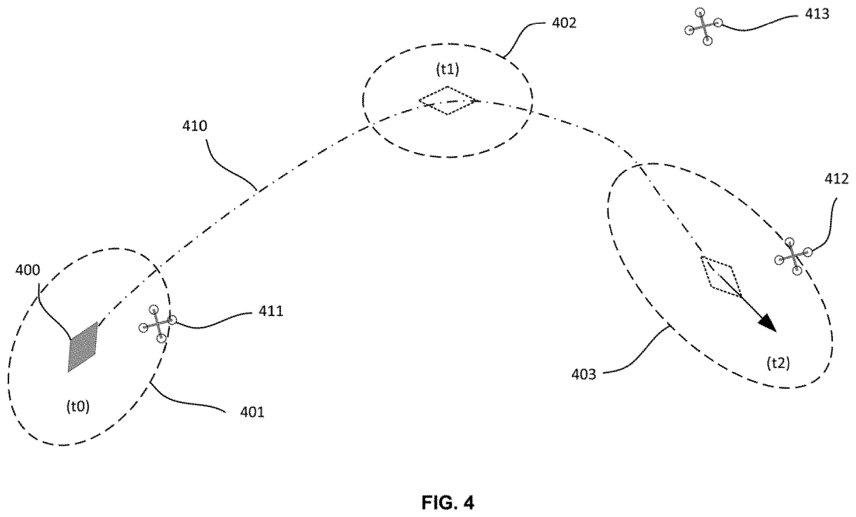

FIG. 4 shows an example of applying safe operation buffer zone at different time points in accordance with embodiments of the disclosure. As shown in FIG. 4, an operating object 400 is moving along a planned course of operation 410. At the time point, t0, the operating object is at location, (x_{0_ac}, y_{0_ac}, z_{0_ac}), in an x-y-z reference coordinate system. Correspondently, the safe operation buffer zone 401 can be defined using a group of geometry constraints. For example, the boundary of the safe operation buffer zone 401 can be represented in the x-y-z reference coordinate system using the following equation.

$${R}_{\{ \text{?} \}} ( x , y , z ) = 0$$

$$\text{?} \text{indicates text missing or illegible when filed}$$

Furthermore, along the planned course of operation, the operating object may be located at (x(t), y(t), z(t)) for any time point, which can be described using the following equation.

$${x}^{′} ( t ) {x}_{0 \text{?}} {f}_{x} ( t )$$

$${y}^{′} ( t ) = {y}_{0 \text{?}} + f - y ( t )$$

$${z}^{′} ( t ) {z}_{\text{?}} {f}_{z} ( t )$$

$$\text{?} \text{indicates text missing or illegible when filed}$$

Correspondently, a safe operation buffer zone for the operating object at any future time point t can be defined using the following equation.

$$\text{?} ( x , y , z ) = \text{?}$$

$$\text{?} \text{indicates text missing or illegible when filed}$$

As shown in FIG. 4, the operating object may be prescribed with a safe operation buffer zone 402 at the time point t1, and the operating object may be prescribed with a safe operation buffer zone 403 at the time point t2. Due to the difference in the movement speed or direction of the operating object, the size and orientation of the safe operation buffer zone 402 and the safe operation buffer zone 403 may change. Also, the shape of the safe operation buffer zone 402 and the safe operation buffer zone 403 may change, due to the difference in the operating conditions for the operating object at different time points.

For a UAV 411, which locates at (x_{0_ua}, y_{0_ua}, z_{0_ua}) at the time point t0, the operating object may determine that the UAV is a present risk, when the following condition is satisfied.

$${R}_{\{ \text{?} \}} ( {x}_{\text{?}} , {y}_{\text{?}} , {z}_{\text{?}} ) < 0$$

$$\text{?} \text{indicates text missing or illegible when filed}$$

Thus, the operating object can send an alert message such as an alarm to the operator of the operating object.

On the other hand, the operating object can determine that the UAV 412 at (x_{1_ua}, y_{1_ua}, z_{1_ua}) is a potential risk, when the following condition is satisfied.

$${R}_{\{ \text{?} \}} ( {x}_{\text{?}} , {y}_{\text{?}} , {z}_{\text{?}} ) < 0$$

$$\text{?} \text{indicates text missing or illegible when filed}$$

Thus, the operating object can send a caution message such as a text message or a caution signal to the operator of the operating object.

Also as shown in FIG. 4, the operating object can determine that the UAV 413 at (x_{2_ua}, y_{2_ua}, z_{2_ua}) is not a risk, since the UAV 413 is not a present risk or a potential risk. Here, the UAV 413 is not present risk for the reason that it is not located within the safe operation zone 401. Also, the UAV 413 is not a potential risk since it is not located within any safe operation zone for any point along the planned course of operation 410, e.g. the safe operation zone 402 at time point t2 and the safe operation zone 403 at time point t3. On the other hand, the UAV 413 may turns into a potential risk if it is determined that the UAV 413 may be moving into one of the safe operation zone 402, 403 at a future time based on the received movement information of the UAV 413. Such analysis may be performed for a set of points along the entire planned course of operation. For example, the set of points may be selected by evaluating a predetermined time interval. Alternatively, the set of points may be selected by evaluating the movement characteristic information of the operating object. For example, the set of points may include a furthest point, a point with maximum translational speed or rotational speed.

In various embodiments, the variable t in the above equations can be used for defining the course of the operation. The variable t may generally refer to an operating state variable, which may be different from time. For example, before an air plane takes off, lands, approaches, or hovers above an airport, the course of the flight may be determined based on the distance from the runway, i.e. the variable t may represent the distance of the UAV from the runway. For example, before an airplane takes off or lands, the navigation system onboard the airplane can detect whether a risk associated with UAV exists along the flight path. If a risk exists, the navigation system can convey a UAV alarm or a warning message to the pilot, so that the pilot can take appropriate avoidance measure, such as avoiding taking-off, avoiding approaching/landing, repeating the fly, taking an alternative route or other active/automatic avoidance measures.

In certain operation condition or stages, the operating object can potentially maintain multiple operation plans at the same time. For example, an airplane may maintain a repeat fly path while it is performing a landing operation. Thus, the navigation control system in the operating object can perform the UAV collision risk analysis for the different plans of course of operation concurrently, so that the operating object can easily switch between different courses during the operation.

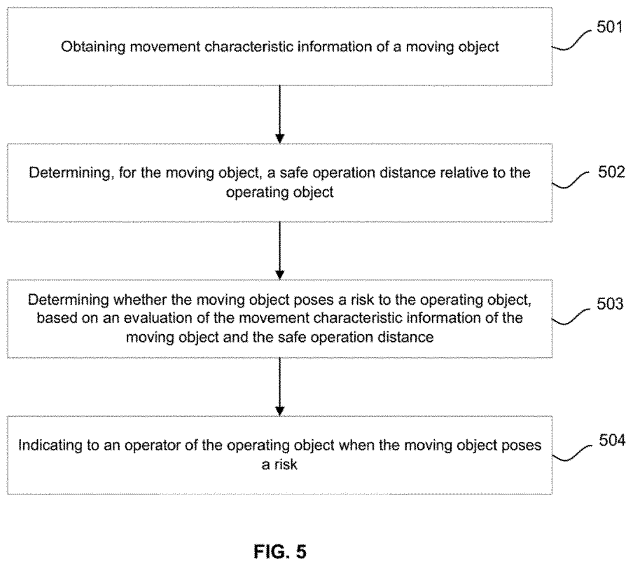

FIG. 5 shows a flowchart of supporting safe operation of an operating object, in accordance with various embodiments of the present disclosure. As shown in FIG. 5, at step 501, an operating object can obtain movement characteristic information of a moving object. At step 502, the operating object can determine a safe operation distance relative to the operating object for the moving object. Furthermore, at step 503, the operating object can determine whether the moving object poses a risk to the operating object, based on an evaluation of the movement characteristic information of the moving object and the safe operation distance. Then, at step 504, the operating object can indicate to an operator of the operating object when the moving object poses a risk.

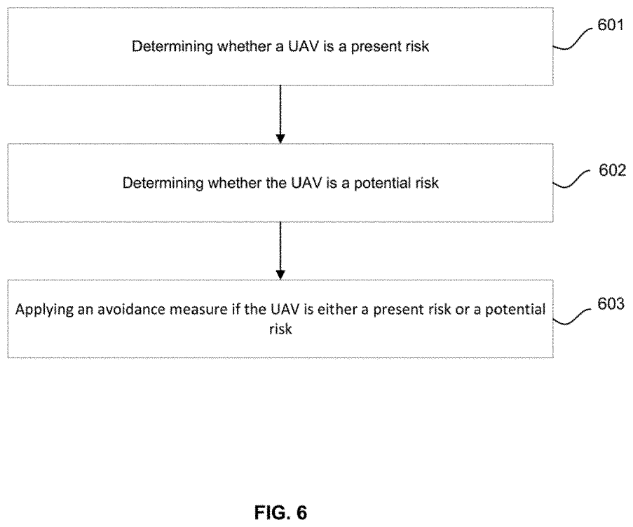

FIG. 6 shows a flowchart of performing collision calculation and avoidance control for an operating object, in accordance with various embodiments of the present disclosure. As shown in FIG. 6, at step 601, the operating object can determine whether a UAV is a present risk by determining whether the UAV is located within a safe operation buffer zone. Furthermore, at step 602, the operating object can determine whether a UAV is a potential risk by determining whether the UAV is located within a safe operation buffer zone for one or more future points along the planned operation course. Then, at step 603, the operating object can apply an avoidance measure when the UAV is either a present risk or a potential risk.

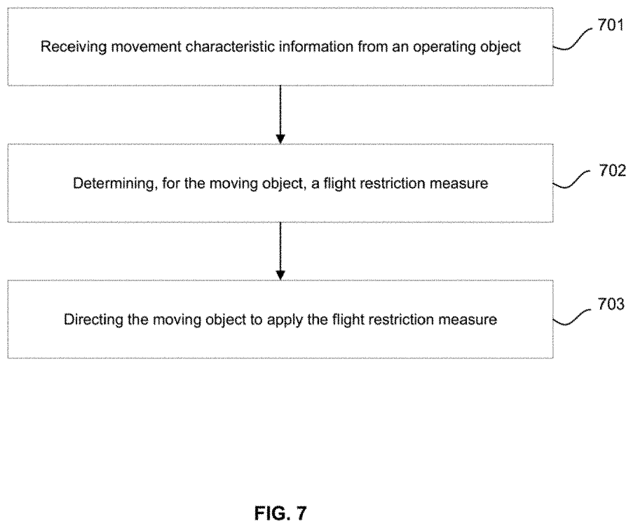

FIG. 7 shows a flowchart of applying flight restriction for a moving object, in accordance with various embodiments of the present disclosure. As shown in FIG. 7, at step 701, the moving object, such as a UAV, can receive movement characteristic information from an operating object. Furthermore, the moving object can determine a flight restriction measure based on the received movement characteristic information of the operating object. Then, at step 703, the moving object can apply the flight restriction measure in order to ensure the safe operation of the operating object.

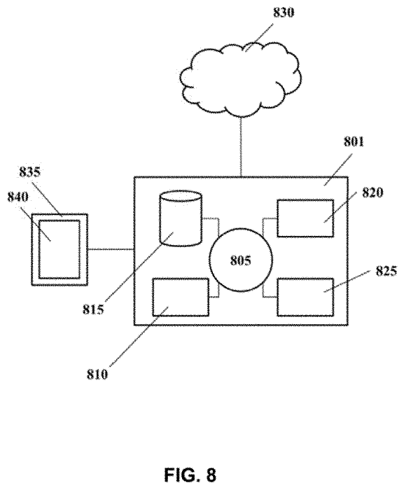

Computer control systems are provided that are programmed to implement methods of the disclosure. For example, various control systems, unit, and components as described in the above can be implemented or embodied using a computer control system. FIG. 8 shows a computer system 801 that is programmed or otherwise configured to implement methods for controlling the operation of an operating object or the operation of the flight of a UAV. The computer system 801 can regulate various aspects of the present disclosure, such as, for example, methods for controlling flight of an aerial vehicle, such as a commercial airliner or an UAV. The computer system 801 can be an electronic device of a user or a computer system that is remotely located with respect to the electronic device. The electronic device can be a mobile electronic device.

The computer system 801 includes a central processing unit (CPU, also “processor” and “computer processor” herein) 805, which can be a single core or multi core processor, or a plurality of processors for parallel processing. The computer system 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 705 through a communication bus (solid lines), such as a motherboard. The storage unit 815 can be a data storage unit (or data repository) for storing data. The computer system 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the computer system 801, can implement a peer-to-peer network, which may enable devices coupled to the computer system 801 to behave as a client or a server.

The CPU 805 can execute a sequence of machine-readable instructions, which can be embodied in a program or software. The instructions may be stored in a memory location, such as the memory 810. The instructions can be directed to the CPU 705, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. The CPU may be integrated into an operating object, on-board an operating object, integrated into a UAV, on-board a UAV, or part of a communication channel (e.g., cloud network). In some cases, the circuit is an application specific integrated circuit (ASIC).

The storage unit 815 can store files, such as drivers, libraries and saved programs. The storage unit 815 can store user data, e.g., user preferences and user programs. The computer system 801 in some cases can include one or more additional data storage units that are external to the computer system 801, such as located on a remote server that is in communication with the computer system 801 through an intranet or the Internet. The storage unit may be integrated into an operating object, on-board an operating object, integrated into a UAV, on-board a UAV, or part of a communication channel (e.g., cloud network). The storage unit may store a safe operation database.

The computer system 801 can communicate with one or more remote computer systems through the network 830. For instance, the computer system 801 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 801 via the network 830. The network may comprise a wireless communication network (e.g., a cloud network).

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software (e.g., a computer software or a mobile application such as cell phone app). During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, input parameters for methods of UAV safe operation for stationary and moving objects. Examples of UIs include, without limitation, a graphical user interface (GUI) and web-based user interface. The UI may be part of a UAV's remote control. The UI may be part of an operating object and controlled by the operating object's user or operator.

Methods and systems of the present disclosure can be implemented by way of one or more algorithms. An algorithm can be implemented by way of software upon execution by the central processing unit 805. The algorithm can, for example, control flight of a UAV

The systems, devices, and methods described herein can be applied to a wide variety of moving objects. As previously mentioned, any description herein of a UAV may apply to and be used for any moving object. Any description herein of a UAV may apply to any aerial vehicle. A moving object of the present disclosure can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments. The moving object can be a vehicle, such as a vehicle described elsewhere herein. In some embodiments, the moving object can be carried by a living subject, or take off from a living subject, such as a human or an animal. Suitable animals can include avines, canines, felines, equines, bovines, ovines, porcines, delphines, rodents, or insects.

The moving object may be capable of moving freely within the environment with respect to six degrees of freedom (e.g., three degrees of freedom in translation and three degrees of freedom in rotation). Alternatively, the movement of the moving object can be constrained with respect to one or more degrees of freedom, such as by a predetermined path, track, or orientation. The movement can be actuated by any suitable actuation mechanism, such as an engine or a motor. The actuation mechanism of the moving object can be powered by any suitable energy source, such as electrical energy, magnetic energy, solar energy, wind energy, gravitational energy, chemical energy, nuclear energy, or any suitable combination thereof. The moving object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the moving object may be carried by a living being.

In some instances, the moving object can be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the moving object to take off from a surface, land on a surface, maintain its current position and/or orientation (e.g., hover), change orientation, and/or change position.

The moving object can be controlled remotely by a user or controlled locally by an occupant within or on the moving object. In some embodiments, the moving object is an unmanned moving object, such as a UAV. An unmanned moving object, such as a UAV, may not have an occupant onboard the moving object. The moving object can be controlled by a human or an autonomous control system (e.g., a computer control system), or any suitable combination thereof. The moving object can be an autonomous or semi-autonomous robot, such as a robot configured with an artificial intelligence.

The moving object can have any suitable size and/or dimensions. In some embodiments, the moving object may be of a size and/or dimensions to have a human occupant within or on the vehicle. Alternatively, the moving object may be of size and/or dimensions smaller than that capable of having a human occupant within or on the vehicle. The moving object may be of a size and/or dimensions suitable for being lifted or carried by a human. Alternatively, the moving object may be larger than a size and/or dimensions suitable for being lifted or carried by a human. In some instances, the moving object may have a maximum dimension (e.g., length, width, height, diameter, diagonal) of less than or equal to about: 2 cm, 5 cm, 10 cm, 50 cm, 1 m, 2 m, 5 m, or 10 m. The maximum dimension may be greater than or equal to about: 2 cm, 5 cm, 10 cm, 50 cm, 1 m, 2 m, 5 m, or 10 m. For example, the distance between shafts of opposite rotors of the moving object may be less than or equal to about: 2 cm, 5 cm, 10 cm, 50 cm, 1 m, 2 m, 5 m, or 10 m. Alternatively, the distance between shafts of opposite rotors may be greater than or equal to about: 2 cm, 5 cm, 10 cm, 50 cm, 1 m, 2 m, 5 m, or 10 m.

In some embodiments, the moving object may have a volume of less than 100 cm×100 cm×100 cm, less than 50 cm×50 cm×30 cm, or less than 5 cm×5 cm×3 cm. The total volume of the moving object may be less than or equal to about: 1 cm3, 2 cm3, 5 cm3, 10 cm3, 20 cm3, 30 cm3, 40 cm3, 50 cm3, 60 cm3, 70 cm3, 80 cm3, 90 cm3, 100 cm3, 150 cm3, 200 cm3, 300 cm3, 500 cm3, 750 cm3, 1000 cm3, 5000 cm3, 10,000 cm3, 100,000 cm3, 1 m3, or 10 m3. Conversely, the total volume of the moving object may be greater than or equal to about: 1 cm3, 2 cm3, 5 cm3, 10 cm3, 20 cm3, 30 cm3, 40 cm3, 50 cm3, 60 cm3, 70 cm3, 80 cm3, 90 cm3, 100 cm3, 150 cm3, 200 cm3, 300 cm3, 500 cm3, 750 cm3, 1000 cm3, 5000 cm3, 10,000 cm3, 100,000 cm3, 1 m3, or 10 m3.

In some embodiments, the moving object may have a footprint (which may refer to the lateral cross-sectional area encompassed by the moving object) less than or equal to about: 32,000 cm2, 20,000 cm2, 10,000 cm2, 1,000 cm2, 500 cm2, 100 cm2, 50 cm2, 10 cm2, or 5 cm2. Conversely, the footprint may be greater than or equal to about: 32,000 cm2, 20,000 cm2, 10,000 cm2, 1,000 cm2, 500 cm2, 100 cm2, 50 cm2, 10 cm2, or 5 cm2.

In some instances, the moving object may weigh no more than 1000 kg. The weight of the moving object may be less than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg. Conversely, the weight may be greater than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg.

In some embodiments, a moving object may be small relative to a load carried by the moving object. The load may include a payload and/or a carrier, as described in further detail elsewhere herein. In some examples, a ratio of a moving object weight to a load weight may be greater than, less than, or equal to about 1:1. In some instances, a ratio of a moving object weight to a load weight may be greater than, less than, or equal to about 1:1. Optionally, a ratio of a carrier weight to a load weight may be greater than, less than, or equal to about 1:1. When desired, the ratio of an moving object weight to a load weight may be less than or equal to: 1:2, 1:3, 1:4, 1:5, 1:10, or even less. Conversely, the ratio of a moving object weight to a load weight can also be greater than or equal to: 2:1, 3:1, 4:1, 5:1, 10:1, or even greater.

In some embodiments, the moving object may have low energy consumption. For example, the moving object may use less than about: 5 W/h, 4 W/h, 3 W/h, 2 W/h, 1 W/h, or less. In some instances, a carrier of the moving object may have low energy consumption. For example, the carrier may use less than about: 5 W/h, 4 W/h, 3 W/h, 2 W/h, 1 W/h, or less. Optionally, a payload of the moving object may have low energy consumption, such as less than about: 5 W/h, 4 W/h, 3 W/h, 2 W/h, 1 W/h, or less.

Many features of the present disclosure can be performed in, using, or with the assistance of hardware, software, firmware, or combinations thereof. Consequently, features of the present disclosure may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present disclosure can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Features of the disclosure may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A method for supporting safe operation of operating object, comprising:
obtaining movement characteristic information of a moving object;
determining, for the moving object, a safe operation distance relative to the operating object;
determining whether the moving object poses a risk to the operating object based on an evaluation of the movement characteristic information of the moving object and the safe operation distance; and
generating a warning signal in response to the moving object being determined to pose the risk.

2. The method of claim 1, wherein the movement characteristic information of the moving object comprises at least one of a location, a movement direction, a movement speed, or an acceleration rate of the moving object.

3. The method of claim 1, wherein the safe operation distance is determined based on at least one of a moving object characteristic, an operating object characteristic, a communication characteristic between the operating object and the moving object, or a situational characteristic,
wherein the moving object characteristic comprises at least one of a moving object classification, a moving object priority, a moving object specification or size, moving objecting timing information, a moving object data processing rate, or a moving object maneuverability,
wherein the operating object characteristic comprises at least one of an operating object classification, operating object movement information, or operating object timing information,
wherein the communication characteristic comprises communication information associated with communication time between the operating object and the object, and
wherein the situational characteristic comprises at least one of an environmental condition or a weather condition.

4. The method of claim 1, further comprising:
updating the safe operation distance periodically, in real-time, or in response to one or more events,
wherein the one or more events comprise at least one of a detected action received from the moving object, a detected action generated by the operating object, a request received from the moving object or a remote device, a request generated by the operating device, or an event associated with a communication system.

5. The method of claim 1, wherein the operating object is associated with a safe operation buffer zone defined by the safe operation distance, wherein the safe operation buffer zone is a 2-D or 3-D safe operation region, and wherein the safe operation distance is in a lateral direction, a vertical direction, or a combination of lateral and vertical directions relative to a reference frame.

6. The method of claim 5, further comprising:
transmitting the warning signal or flight restriction information to a remote device controlling the moving object when the moving object is determined to pose the risk, or
broadcasting the warning signal or the flight restriction information to remote devices controlling moving objects when the moving objects the safe operation buffer zone.

7. The method of claim 1, further comprising:
receiving identification information from the moving object; and
identifying and/or locating a remote device controlling the moving object based on the identification information.

8. The method of claim 1,
wherein the risk is a present risk when the moving object is within the safe operation distance relative to the operating object, or
wherein the risk is a potential risk when the moving object is within the safe operation distance relative to the operating object at a future point based on a predetermined operation plan.

9. The method of claim 1, further comprising:
initiating an avoidance measure to avoid the moving object, wherein the avoidance measure is initiated automatically or manually via receiving user input.

10. The method of claim 9, wherein the avoidance measure comprises:
transmitting the warning signal to a remote device controlling the moving object, or transmitting control signals to the moving object for adjusting a flight path of the moving object,
wherein adjusting the flight path comprises:
adjusting at least one of an altitude, a direction, an orientation, a speed, or an acceleration rate of the moving object; or
controlling the moving object to perform a forced landing.

11. A non-transitory computer-readable medium with instructions stored thereon; that when executed by a processor, perform a method comprising:
obtaining movement characteristic information of a moving object;
determining, for the moving object, a safe operation distance relative to an operating object;
determining whether the moving object poses a risk to the operating object based on an evaluation of the movement characteristic information of the moving object and the safe operation distance; and
generating a warning signal in response to the moving object being determined to pose the risk.

12. The non-transitory computer-readable medium of claim 11, wherein the movement characteristic information of the moving object comprises at least one of a location, a movement direction; a movement speed, or an acceleration rate of the moving object.

13. The non-transitory computer-readable medium of claim 11, wherein the safe operation distance is determined based on at least one of a moving object characteristic, an operating object characteristic, a communication characteristic between the operating object and the moving object, or a situational characteristic,
wherein the moving object characteristic comprises at least one of a moving object classification, a moving object priority, a moving object specification or size, moving objecting timing information, a moving object data processing rate, or a moving object maneuverability,
wherein the operating object characteristic comprises at least one of an operating object classification, operating object movement information, or operating object timing information,
wherein the communication characteristic comprises communication information associated with communication time between the operating object and the object, and
wherein the situational characteristic comprises at least one of an environmental condition or a weather condition.

14. The non-transitory computer-readable medium of claim 11, wherein the operating object is associated with a safe operation buffer zone defined by the safe operation distance, wherein the safe operation buffer zone is a 2-D or 3-D safe operation region, and wherein the safe operation distance is in a lateral direction, a vertical direction, or a combination of lateral and vertical directions relative to a reference frame.

15. The non-transitory computer-readable medium of claim 14, wherein the method further comprises:
transmitting the warning signal or flight restriction information to a remote device controlling the moving object when the moving object is determined to pose the risk, or
broadcasting the warning signal or the flight restriction information to remote devices controlling moving objects when the moving objects enter the safe operation buffer zone.

16. The non-transitory computer-readable medium of claim 11, wherein the method further comprises:
receiving identification information from the moving object; and
identifying and/or locating a remote device controlling the moving object based on the identification information.

17. The non-transitory computer-readable medium of claim 11,
wherein the risk is a present risk when the moving object is within the safe operation distance relative to the operating object, or
wherein the risk is a potential risk when the moving object is within the safe operation distance relative to the operating object at a future point based on a predetermined operation plan.

18. The non-transitory computer-readable medium of claim 11, wherein the method further comprises:
initiating an avoidance measure to avoid the moving object, wherein the avoidance measure is initiated automatically or manually receiving user input.

19. The non-transitory computer-readable medium of claim 8, wherein the avoidance measure comprises:
transmitting the warning signal to a remote device controlling the moving object, or transmitting control signals to the moving object for adjusting a flight path of the moving object,
wherein adjusting the flight path comprises:
adjusting at least one of an altitude, a direction, an orientation, a speed, or an acceleration rate of the moving object, or
controlling the moving object to perform a forced landing.

20. An apparatus for supporting safe operation of an operating object, the apparatus comprising:
one or more processors configured to:
obtain movement characteristic information of a moving object;
determine, for the moving object, a safe operation distance relative to the operating object;
determine whether moving object poses a risk to the operating object based on an evaluation of the movement characteristic information of the moving object and the safe operation distance; and
generate a warning signal when the moving object is determined to pose the risk.
